(19) United States
(12) Patent Application Publication
(10) Pub. No.: US 2019/0378013 A1
(43) Pub. Date: Dec. 12, 2019

(54) SELF-TUNING MODEL COMPRESSION METHODOLOGY FOR RECONFIGURING DEEP NEURAL NETWORK AND ELECTRONIC DEVICE

(71) Applicant: Kneron Inc., San Diego, CA (US)

(72) Inventors: JIE WU, San Diego, CA (US); JUNJIE SU, San Diego, CA (US); Bike Xie, San Diego, CA (US); Chun-Chen Liu, San Diego, CA (US)

(21) Appl. No.: 16/001,923

(22) Filed: Jun. 6, 2018

(51) Int. Cl. G06N 3/08; G06N 3/04; G06N 3/063

(52) U.S. Cl. CPC G06N 3/082; G06N 3/063; G06N 3/0454

(57) ABSTRACT

A self-tuning model compression methodology for reconfiguring a Deep Neural Network includes: receiving a DNN model and a data set, wherein the DNN includes an input layer, at least one hidden layer and an output layer, and said at least one hidden layer and the output layer of the DNN model includes a plurality of neurons; compressing the DNN model into a reconfigured model according to the data set, wherein the reconfigured model includes an input layer, at least one hidden layer and an output layer, and said at least one hidden layer and the output layer of the reconfigured model includes a plurality of neurons, and a size of the reconfigured model is smaller than a size of the DNN model; and executing the reconfigured model on a user terminal for an end-user application.

### BACKGROUND OF THE INVENTION

### 1. Field of the Invention

The present invention relates to a Deep Neural Network (DNN), and more particularly, to a method for reconfiguring a DNN model and an associated electronic device.

### 2. Description of the Prior Art

Large scale Deep Neural Networks have achieved remarkable results performing cutting-edge tasks in the fields of computer vision, image recognition, and speech recognition. Thanks to intensive computational power and a large amount of data and memory storage, deep earning models become bigger and deeper, enabling them to better learn from scratch. However, the high computation intensity of these models cannot be deployed at a resource-limited end-user with low memory storage and computing capabilities such as mobile phones and embedded devices. Moreover, learning from scratch is not feasible for end-users because of the limited data set. It means that end-users cannot develop customized deep learning models based on a very limited dataset.

### SUMMARY OF THE INVENTION

One of the objectives of the present invention is therefore to provide a self-tuning model compression methodology for reconfiguring a deep neural network, and an associated electronic device.

According to an embodiment of the present invention, the proposed methodology for reconfiguring a Deep Neural Network is disclosed, including two components: (1) a pre-trained DNN model and a dataset, wherein the pre-trained DNN model consists of a number of stacked layers including a plurality of neurons. These staked layers extract low, middle, and high level feature maps and lead the results on dataset. (2) A self-tuning model compression framework compresses the pre-trained DNN model into a smaller size DNN model with acceptable computational complexity and accuracy loss from a limited dataset. The compressed smaller size DNN model can be applied on an end-user application.

According to an embodiment of the present invention, an electronic device is disclosed, comprising: a storage device arranged to store a program code, and a processor arranged to execute the program code. As processors load and execute the program code, the code instructs the processor to execute the following steps: (1) receive a pre-trained DNN model and a dataset; (2) compress the pre-trained DNN model into a smaller size DNN model according to the dataset with acceptable computational complexity and accuracy loss.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a three-layer artificial neural network.

FIG. 2 is a flowchart illustrating a method for reconfiguring a DNN model according to an embodiment of the present invention.

FIG. 3 is a flowchart illustrating steps of compressing the DNN model into a reconfigured model according to an embodiment of the present invention.

FIG. 4 is a diagram illustrating an electronic device according to an embodiment of the present invention.

### DETAILED DESCRIPTION

Certain terms are used throughout the description and following claims to refer to particular components. As one skilled in the art will appreciate, manufacturers may refer to a component by different names. This document does not intend to distinguish between components that differ in name but not function. In the following description and in the claims, the terms “include” and “comprise” are used in an open-ended fashion, and thus should not be interpreted as a close-ended term such as “consist of”. Also, the term “couple” is intended to mean either an indirect or direct electrical connection. Accordingly, if one device is coupled to another device, that connection may be through a direct electrical connection, or through an indirect electrical connection via other devices and connections.

The idea of artificial neural networks has existed for a long time; nevertheless, limited computational ability of hardware has been an obstacle to related research. Over the last decade, there has been significant progress in computational capabilities of processors and algorithms of machine learning. Only recently has an artificial neural network that can generate reliable judgments become possible. Gradually, artificial neural networks are being experimented with in many fields such as autonomous vehicles, image recognition, natural language understanding, and data mining.

Neurons are the basic computation units in a brain. Each neuron receives input signals from its dendrites and produces output signals along its single axon (usually provided to other neurons as input signals). The typical operation of an artificial neuron can be modeled as:

$$y = f ( {\sum }_{i} {w}_{i} {x}_{i} + b )$$

wherein x represents the input signal and y represents the output signal. Each dendrite multiplies its input signal x by a weight w; this parameter is used to simulate the strength of influence of one neuron on another. The symbol b represents a bias contributed by the artificial neuron itself. The symbol f represents a specific nonlinear function and is generally implemented as a sigmoid function, hyperbolic tangent function, or rectified linear function in practical computation.

For an artificial neural network, the relationship between its input data and final judgment is in effect defined by the weights and biases of all the artificial neurons in the network. In an artificial neural network adopting supervised learning, training samples are fed to the network. Then, the weights and biases of artificial neurons are adjusted with the goal of finding out a judgment policy where the judgments can match the training samples. In an artificial neural network adopting unsupervised learning, whether a judgment matches the training sample is unknown. The network adjusts the weights and biases of artificial neurons and tries to find out an underlying rule. No matter which kind of learning is adopted, the goals are the same—finding out suitable parameters (i.e. weights and biases) for each neuron in the network. The determined parameters will be utilized in future computation.

Currently, most artificial neural networks are designed with a multi-layer structure. Layers serially connected between the input layer and the output layer are called hidden layers. The input layer receives external data and does not perform computation. In a hidden layer or the output layer, input signals are the output signals generated by its previous layer, and each artificial neuron included therein respectively performs computation according to the aforementioned equation. Each hidden layer and output layer can respectively be a convolutional layer or a fully-connected layer. The main difference between a convolutional layer and a fully-connected layer is that neurons in a fully connected layer have full connections to all neurons in its previous layer, whereas neurons in a convolutional layer are only connected to a local region of its previous layer. Many artificial neurons in a convolutional layer share parameters.

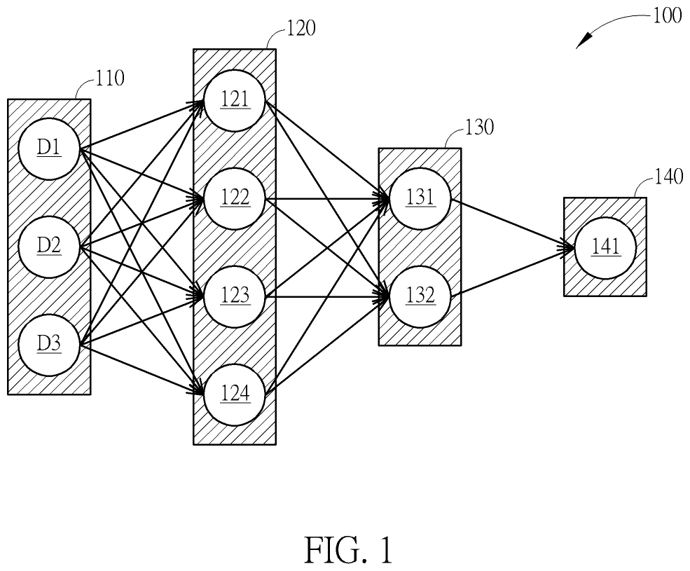

FIG. 1 is a diagram illustrating a three-layer artificial neural network as an example. It should be noted that, although actual artificial neural networks include many more artificial neurons and have more complicated interconnections than this example, those ordinarily skilled in the art will understand that the scope of the invention is not limited to a specific network complexity. Refer to FIG. 1. The input layer 110 is used for receiving external data D1-D3. There are two hidden layers between the input layer 110 and the output layer 140. The hidden layers 120 and 130 are fully-connected layers. The hidden layer 120 includes four artificial neurons (121˜124) and the hidden layer 130 includes two artificial neuron (131˜132). The output layer 140 includes only one artificial neuron (141).

Currently, neural networks can have a variety of network structures. Each structure has its unique combination of convolutional layers and fully-connected layers. Taking the AlexNet structure proposed by Alex Krizhevsky et al. in 2012 as an example, the network includes 650,000 artificial neurons that form five convolutional layers and three fully-connected layers connected in series.

As the number of layers increases, an artificial neural network can simulate a more complicated function (i.e. a more complicated judgment policy). The number of artificial neurons required in the network will swell significantly, however, introducing a huge burden in the hardware cost. The high computational intensity of these models therefore cannot be deployed at a resource-limited end-user with low memory storage and computing capabilities, such as mobile phones and embedded devices. Besides, a network with this large scale is generally not an optimal solution for an end-user application. For example, the aforementioned AlexNet structure might be used for the recognition of hundreds of objects, but the end-user application might only be applying a network for the recognition of two objects. The pre-trained model with a large scale will not be the optimal solution for the end-user. The present invention provides a method for reconfiguring the DNN and an associated electronic device to solve the aforementioned problem.

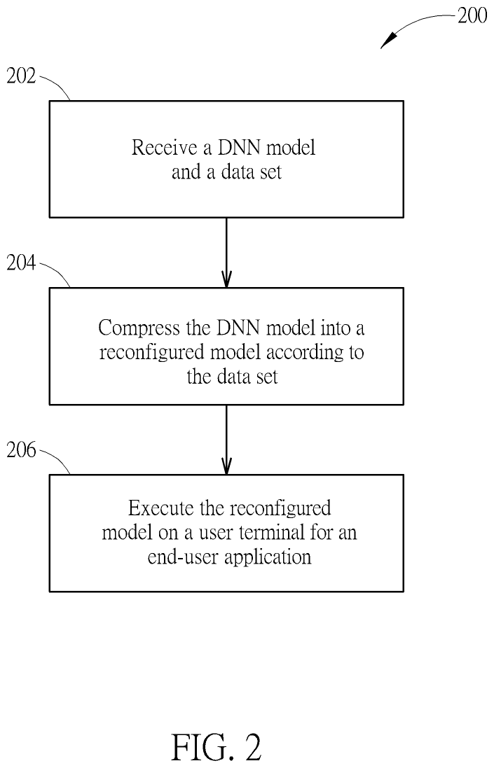

FIG. 2 is a flowchart illustrating a method 200 for reconfiguring a DNN model into a reconfigured model for an end-user terminal according to an embodiment of the present invention. The method is summarized in the following steps. Provided that the result is substantially the same, the steps are not required to be executed in the exact order as shown in FIG. 2.

Step 202: receive a DNN model and a dataset.

As mentioned above, the pre-trained model (for example, the AlexNet structure, VGG16, ReseNet, or MobileNet structure) with the large scale is not applicable for the end-user terminal. In order to satisfy the end-user's requirements, inspired by the transfer-learning technique, we apply the pre-trained model into the end-user terminal for an end-user application via the proposed self-tuning model compression technology. In this way, the pre-trained DNN model can learn customized features from the limited measurement dataset.

Step 204: compress the DNN model into a reconfigured model according to the data set.

In this step, the DNN model is compressed into the reconfigured model which is applicable for the end-user terminal according to the provided dataset. As mentioned above, the DNN model comprises an input layer, at least one hidden layer and an output layer, wherein a neuron is the basic computation unit in each layer. In one embodiment, the compression operation removes a plurality of neurons from the DNN model to form the reconfigured model, so that the number of neurons comprised in the reconfigured model is less than the number of neurons comprised in the pre-trained DNN model. This is not a limitation of the present invention, however. As mentioned above, the typical operation of an artificial neuron can be modeled as:

$$y = f ( {\sum }_{i} {w}_{i} {x}_{i} + b )$$

To implement the above model, each neuron may be implemented by a logic circuit which comprises at least one multiplexer or at least one adder. The compression operation is dedicated to simplify the models of the neurons comprised in the pre-trained model. For example, the compression operation may remove at least one logic circuit from the pre-trained model to simplify the complexity of hardware to form the reconfigured model. In other words, the total number of logic circuits in the reconfigured model is less than in the pre-trained DNN model.

Step 206: execute the self-tuning compression methodology on a user terminal for an end-user application.

After the pre-trained DNN model is compressed by the proposed methodology, the reconfigured model is applicable for the end-user application and executed on the end-user terminal. The end-user application, in this embodiment, can be used for image recognition or speech recognition which is not a limitation of the present invention. Through the compression operation, the pre-trained model with a large scale is compressed into the reconfigured model which is applicable for the end-user application.

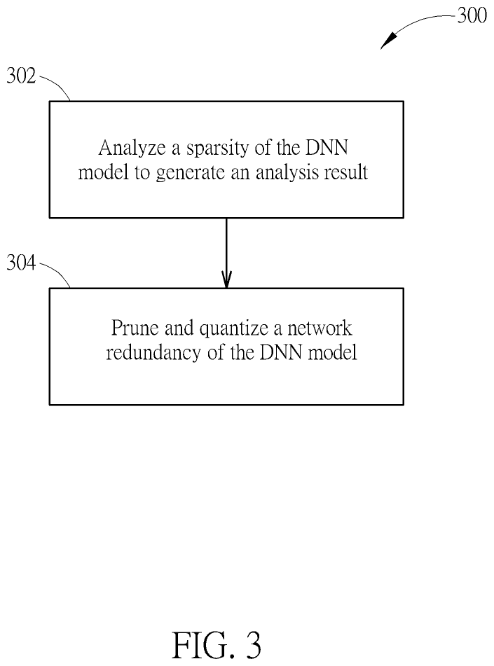

FIG. 3 is a flowchart 300 illustrating steps of compressing the DNN model into a reconfigured model according to an embodiment of the present invention. Provided that the result is substantially the same, the steps are not required to be executed in the exact order shown in FIG. 3.

Step 302: analyze a sparsity of the DNN model to generate an analysis result.

To exploit redundancies within parameters and feature maps for the pre-trained DNN model, the sparsity of the pre-trained DNN model is analyzed, and the analysis result is accordingly generated.

Step 304: prune and quantize a network redundancy of the DNN model.

In this step, in order to find the nest rank of filters, firstly, utilizing the redundancies of neural network, we apply the prune and quantization techniques to compress the network. After that, we apply a low-rank approximation method to the hidden layers and the output later to reduce in the pre-trained DNN model according to an analysis result. As mentioned above, the pre-trained DNN model comprises a plurality of neurons, each neuron corresponding to multiple parameters, e.g. the weight w and the bias b. Among these parameters, some are redundant and do not contribute a lot to the output. If the neurons could be ranked in the network according to the contribution, the low ranking neurons from the network could be removed to generate a smaller and faster network, i.e. the reconfigured model. For example, the ranking can be done according to the L1/L2 mean of neuron weights, the mean activations, or the number of times of not being zero on some validation set, etc. It should be noted that the reconfigured model can still be finely tuned (or retrained) based on the provided data set in order to construct the base model to describe the common features of the end-user application. This should be a well-known technique for those skilled in the art; the detailed description is omitted here for brevity.

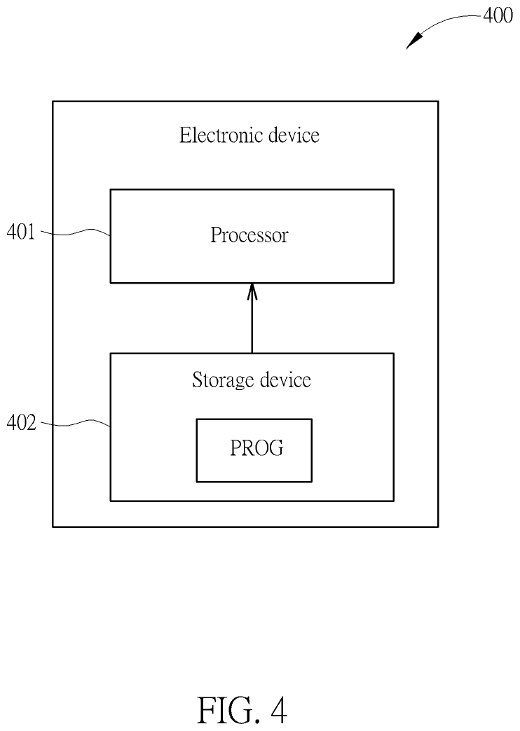

FIG. 4 is a diagram illustrating an electronic device 40 according to an embodiment of the present invention. As shown in FIG. 4, the electronic device 400 comprises a processor 401 and a storage device 402, wherein the storage device 402 stores a program code PROG. The storage device 402 may be a volatile memory or a non-volatile memory. The flow described in the implementation of FIG. 2 and FIG. 3 will be executed if the program code PROG stored in the storage device 402 is loaded and executed by the processor 401. The person skilled in the art should understand the implementation readily after reading the above paragraphs; a detailed description is thus omitted here for brevity.

Briefly summarized, by compressing the pre-trained DNN model with a large scale to remove its redundancy, a reconfigured model with a customized model size and having an acceptable computational complexity is generated.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A self-tuning model compression methodology for reconfiguring a Deep Neural Network (DNN), comprising:
receiving a DNN model and a data set, wherein the DNN model comprises an input layer, at least one hidden layer and an output layer, and said at least one hidden layer and the output layer of the DNN model comprise a plurality of neurons;
compressing the DNN model into a reconfigured model according to the data set, wherein the reconfigured model comprises an input layer, at least one hidden layer and an output layer, and said at least one hidden layer and the output layer of the reconfigured model comprise a plurality of neurons, and a size of the reconfigured model is smaller than a size of the DNN model; and
executing the reconfigured model on a user terminal for an end-user application.

2. The methodology of claim 1, wherein compressing the DNN model into the reconfigured model according to the data set comprises:
analyzing a sparsity of the DNN model to generate an analysis result; and
generating the reconfigured model by pruning and quantizing a network redundancy of the DNN model, wherein pruning and quantizing the network redundancy of the DNN model comprises:
applying a low-rank approximation method to said at least one hidden layer and the output layer of the DNN model according to the analysis result.

3. The methodology of claim 1, wherein a number of the plurality of neurons of the reconfigured model is less than a number of the plurality of neurons of the DNN model.

4. The methodology of claim 1, wherein each of the plurality of neurons of the reconfigured model corresponds to at least one logic circuit comprising at least one of a multiplexer and an adder, each of the plurality of neurons of the DNN model corresponds to at least one logic circuit comprising at least one of a multiplexer and an adder, and a number of logic circuits in the reconfigured model is less than a number of logic circuits in the DNN model.

5. The methodology of claim 1, further comprising:
retraining the reconfigured model with the data set.

6. The methodology of claim 1, wherein the DNN model is an AlexNet, a VGG16, a RestNet, a MobileNet, a Yolo Network, and so on.

7. The methodology of claim 1, wherein each of said at least one hidden layer and the output layer of the reconfigured model is a convolutional layer or a fully-connected layer.

8. The methodology of claim 1, wherein the end-user application is a visual recognition application or a speech recognition application.

9. An electronic device, comprising:
a storage device, arranged to store a program code; and
a processor, arranged to execute the program code;
wherein when loaded and executed by the processor, the program code instructs the processor to execute the following steps:
receiving a DNN model and a data set, wherein the DNN comprises an input layer, at least one hidden layer and an output layer, and said at least one hidden layer and the output layer of the DNN model comprise a plurality of neurons; and
compressing the DNN model into a reconfigured model according to the data set, wherein the reconfigured model comprises an input layer, at least one hidden layer and an output layer, and said at least one hidden layer and the output layer of the reconfigured model comprise a plurality of neurons, and a size of the reconfigured model is smaller than a size of the DNN model.

10. The electronic device of claim 9, wherein compressing the DNN model into the reconfigured model according to the data set comprises:
analyzing a sparsity of the DNN model to generate an analysis result; and
generating the reconfigured model by pruning and quantizing a network redundancy of the DNN model, wherein pruning and quantizing the network redundancy of the DNN model comprises:
applying a low-rank approximation method to said at least one hidden layer and the output layer of the DNN model according to the analysis result.

11. The electronic device of claim 9, wherein a number of the plurality of neurons of the reconfigured model is less than a number of the plurality of neurons of the DNN model.

12. The electronic device of claim 9, wherein each of the plurality of neurons of the reconfigured model corresponds to at least one of a multiplexer and an adder, each of the plurality of neurons of the DNN model corresponds to at least one of a multiplexer and an adder, and a number of multiplexers and adders in the reconfigured model is less than a number of multiplexers and adders in the DNN model.

13. The electronic device of claim 9, wherein the program code instructs the processor to further execute the following steps:
retraining the reconfigured model with the data set.

14. The electronic device of claim 9, wherein the DNN model is an AlexNet, a VGG16, a RestNet, a MobileNet, a Yolo Network, and so on.

15. The electronic device of claim 9, wherein each of said at least one hidden layer and the output layer of the reconfigured model is a convolutional layer or a fully-connected layer.

16. The electronic device of claim 9, wherein the reconfigured model is executed on a user terminal for an end-user application.

17. The electronic device of claim 16, wherein the end-user application is a visual recognition application or a speech recognition application.
